(19) United States
(12) Patent Application Publication
(10) Pub. No.: US 2015/0330065 A1
(43) Pub. Date: Nov. 19, 2015

(54) MULTI FACETED SHOWER HEAD MECHANISM

(71) Applicant: Raymond Hassanlou, Sherman Oaks, CA (US)

(72) Inventor: Raymond Hassanlou, Sherman Oaks, CA (US)

(21) Appl. No.: 14/276,899

(22) Filed: May 13, 2014

(51) Int. Cl. E03C 1/02; B05B 1/18

(52) U.S. Cl. CPC E03C 1/023; B05B 1/185

(57) ABSTRACT

An enhanced shower head mechanism comprises a chamber for collecting and distributing water; one or more long pipes connected to the chamber and one short pipe connected to each of a top and the bottom of the chambers. Preferably, the number of the long pipes is four. Preferably, the pipes are threaded at an end. Each of the threaded long pipes is pivotally connected to a shower head. In another embodiment, the chamber is not used, instead, all long pipes are connected in a crossing configuration with an overlapping center that includes input port that is directly connected to a main shower/bath water source. Each long pipe is pivotally connected to a shower head at its end.

### BACKGROUND OF THE INVENTION

Showering is an activity that millions of people make a part of their daily routine. Its a fast, effective and refreshing way to get clean. A shower (or shower-bath, walk-in shower, steam shower) is a place in which a person bathes under a spray of water, typically warm or hot water. The water is drained through a drain in the shower base. Modern showers come with configurable temperature and spray pressure settings, along with adjustable showerhead nozzle settings¹. ¹ http://en.wikipedia.org/wiki/Shower

A shower head is a perforated nozzle that distributes water over solid angle a focal point of use, generally overhead the bather. A shower uses less water than a full immersion in a bath. Some shower heads can be adjusted to spray different patterns of water, such as massage, gentle spray, strong spray, and intermittent pulse or combination modes. The simplest, least expensive showers have a swiveling nozzle aiming down on the user. More complex showers have a showerhead connected to a hose which has a mounting bracket. This allows the user to spray the water at different parts of their body. A shower can be installed in a small shower stall or in a bathtub². ² See, n.1, Above.

Many couples prefer to shower together at times. However, conventional shower head mechanisms are limited in their range and therefore do not allow more than one person to conveniently shower at the same time.

There is a need for a shower head mechanism that can accommodate two people showering at the same time without the problems of the conventional mechanisms.

### SUMMARY OF THE INVENTION

The enhanced shower head mechanism of the present invention comprises a largely hollow chamber for collecting and distributing water. The shower head mechanism includes an inlet port for receiving water from the main water supply pipe and two or more outlets for providing outflow for the received water.

In one embodiment, one short pipe is connected to the inlet port for receiving water and two or more long pipes are connected to the outlet ports for distributing the received water. Preferably, the number of the output ports and the long pipes connected thereto is four. Preferably, the pipes are threaded at an end. Each of the threaded long pipes is pivotally connected to a shower head.

The short pipe at the top of chamber connects to the main water line just like a regular shower head would. The other pipes and the short pipe under the chamber connect to any standard shower head. Advantageously, the showerheads connected to this device can pivot in different directions providing water to the entirety of the body. Advantageously, by turning the showerheads to and/or away from each other, two people can shower comfortably together. In one embodiment, five showerheads can get attached to this device and make it a massive rain shower. Advantageously, using this device and connecting ordinary inexpensive showerheads to the device can turn a regular bath into a bonanza of rain shower.

These and other objects of the shower head mechanism of the present invention will become readily apparent with reference to the drawings and following description.

### BRIEF DESCRIPTION OF THE DRAWINGS

FIG. 1 is a schematic diagram of a top view of the shower head mechanism according to an exemplary embodiment of the present invention.

FIG. 2 is a schematic diagram of a side view of the shower head mechanism according to an exemplary embodiment of the present invention.

### DETAILED DESCRIPTION OF THE PREFERRED EMBODIMENT(S)

Details of the various embodiments of the present invention will now be discussed by reference to the drawings.

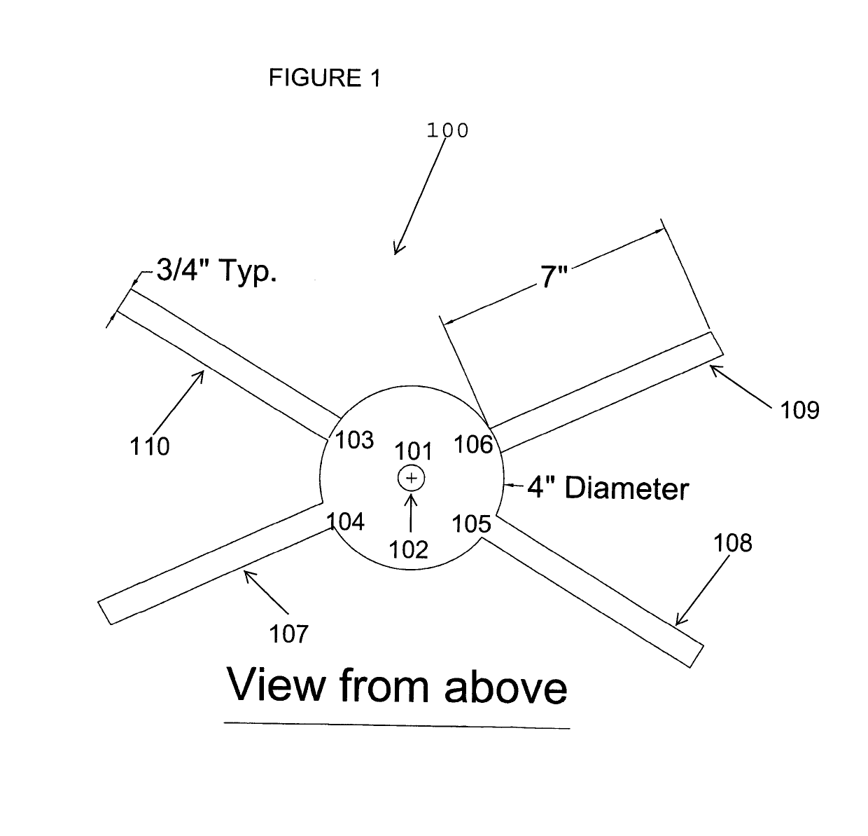

FIG. 1 is a schematic diagram depicting a top view of the inventive shower head mechanism according to an exemplary embodiment of the present invention. Shower head mechanism is identified by reference numeral 100. Shower head mechanism 100 includes chamber 101 that is utilized for collecting and distribution of incoming water. Inlet port 102, through which incoming water is received, is preferably located on top of the chamber 101.

Chamber 101 receives water from main shower pipe (not shown) through inlet port 102 that is connected to a short pipe (not shown). Preferably, the connecting pipe 102 is threaded and is ¾ inch in diameter. Chamber 101 distributes incoming water through four outlet ports identified by reference numerals 103, 104, 105 and 106 each of which is connected to long pipes identified by reference numerals 107, 108, 109 and 110.

Long pipes 107 to 110 can be of any length that accomplishes the purpose of allowing two persons to comfortably shower at the same time considering the size of the shower area. Preferably, the long pipes 107 to 110 are 7 inches long. Chamber can be of any suitable shape and size. In one exemplary embodiment the Chamber 101 is half dome shaped and is 4 inches in diameter. Long pipes 107 to 110 can be spaced in any suitable spacing. In one exemplary embodiment, long pipes 107 to 110 are evenly spaced apart.

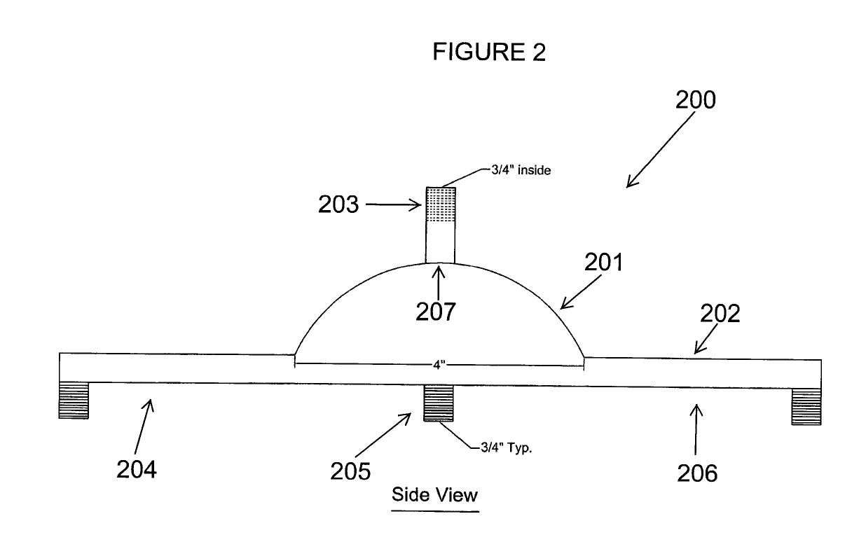

FIG. 2 is a schematic diagram depicting a side view of the inventive shower head mechanism according to an exemplary embodiment of the present invention. In this depiction, shower head mechanism is identified by reference numeral 200. Shower head mechanism 200 includes chamber 201 that is utilized for collecting and distribution of incoming water.

Chamber 201 includes inlet port 207 on its top, through which incoming water is received from the main supply line (not shown). Preferably, inlet port 207 is connected to short pipe 203 that attaches to the main water pipe (not shown). As viewed from this angle, chamber 201 is connected to long pipes 204 and 206 and short pipe 205. Short pipe 205 is located directly below the short pipe 203 which is located on the top of the chamber 201. Each of the long pipes 204, 206 and short pipe 206 (located in the bottom of chamber 201) are connected to a shower head (not shown). Preferably, the connection between shower heads and the pipes is pivotal to allow a comfortable range for two persons showering at the same time.

In yet another embodiment of the present invention, the chamber is not included in the shower head mechanism. Instead, the long pipes, preferably four in number, are connected in a plus (+) configuration, the center of which included an inlet port that is directly connected to a main water supply for the shower/bath.

The invention may be embodied in other specific forms without departing from the spirit or essential characteristics thereof. The present embodiment is, therefore, to be considered in all respects as illustrative and not restrictive, the scope of the invention being indicated by the appended claims and all changes which come within the meaning and range of equivalency of the claims are, therefore, intended to be embraced therein.

What is claimed is:

1. An enhanced shower head mechanism comprising:
A substantially hollow chamber having an axial inlet port at a top end for receiving and collecting water;
One or more outlet ports at a bottom end of the chamber for expelling water.

2. The shower head mechanism of claim 1, wherein each of the outlet ports is connected to a long pipe.

3. The shower head mechanism of claim 1, wherein the number of the long pipes is four.

4. The shower head mechanism of claim 1, additionally comprising a short pipe connected to the bottom end.

5. The shower head mechanism of claim 4, wherein the short pipes are threaded at an end.

6. The shower head mechanism of claim 3, wherein the long pipes are threaded at an end.

7. The shower head mechanism of claim 6, wherein each of the threaded long pipes are connected to a shower head.

8. The shower head mechanism of claim 1, wherein the inlet port is connected to a short pipe.

9. The shower head mechanism of claim 7, wherein the shower heads can pivot.

10. An enhanced shower head mechanism comprising:
Two or more long pipes connected to each other in a crossing configuration;
An axial inlet port at a center of where the pipes crossing (where the pipes overlap) for receiving water from a shower/bath water source;
One or more outlet ports at the end of each long pipe for expelling water.
